(19) United States
(12) Patent Application Publication
(10) Pub. No.: US 2019/0005410 A1
(43) Pub. Date: Jan. 3, 2019

(54) UNSUPERVISED MACHINE LEARNING MODELS IN HEALTHCARE EPISODE PREDICTION

(71) Applicant: Amino, Inc., San Francisco, CA (US)

(72) Inventors: Shashank Shekhar, San Francisco, CA (US); Sameera Poduri, San Francisco (CA)

(21) Appl. No.: 15/717,858

(22) Filed: Sep. 27, 2017

Related U.S. Application Data
(60) Provisional application No. 62/528,375, filed on Jul. 3, 2017.

(51) Int. Cl. G06N 99/00; G06F 19/00; G06N 7/00

(52) U.S. Cl. CPC G06N 99/005; G06F 19/328; G06N 7/005; G06F 19/322

(57) ABSTRACT

The disclosed embodiments include a method performed by server computer(s). The method includes obtaining private healthcare insurance claims data and public healthcare procedure code data, inserting that data in a n unlabeled fashion into an unsupervised machine learning program to model canonical healthcare episodes. A healthcare episode refers to all the services a given patient receives when visiting a healthcare facility for a particular purpose (e.g., setting a broken arm, giving birth, etc.). A canonical healthcare episode is the most likely episode to be experienced by the population or even a given patient with particular biographic information.

### CROSS REFERENCE TO CO-PENDING APPLICATIONS

This patent application claims the benefit of U.S. provisional patent application Ser. No. 62/528,375, filed Jul. 3, 2017, the entirety of which is incorporated herein by this referent thereto.

### TECHNICAL FIELD

The disclosed teachings relate to data driven predictive models. In particular, the disclosed teachings relate to techniques for detecting canonical episodes of care across a number of patients and health care facilities.

### BACKGROUND

Existing healthcare systems involve numerous interconnected subsystems used to collectively offer and deliver diverse services to consumers. The complexity of the healthcare system will not change in the foreseeable future because it serves a large population of consumers with unique, complex, and diverse needs. The consumers use various resources to research healthcare information and manage their individual healthcare profiles. For example, an individual can access an online portal via a desktop computer or smartphone to research information and maintain a personal profile. This online portal can include tools for researching information related to medical conditions and searching for local doctors that specialize in treating those medical conditions.

Consumers would like to conduct research in light of considerations in facility variability. Unfortunately, this variability is not transparent to consumers. For example, existing healthcare systems do not have central sources for users to search for healthcare costs by any combination of procedures, insurance, healthcare providers, geographic locations, and the like. Instead, healthcare cost information is unavailable or fragmented across disparate data sources. As a result, users cannot make informed decisions about obtaining services at known prices because this information does not exist in any readily accessible form.

A given episode of healthcare including any particular procedure can depend largely on a particular healthcare provider and the terms of a patient's particular insurer. As a result, patients seeking the same procedure from a healthcare provider may be subjected to different costs.

### SUMMARY

The disclosed embodiments include a method performed by server computer(s) to identify component procedures in a healthcare episode via unsupervised machine learning models. The method involves obtaining a number of healthcare records corresponding to a number of healthcare facilities. Amongst the records is data regarding an identification of patients and healthcare facilities, timestamps, procedures performed on the patients, and biographic data for those patients.

A processor sorts the healthcare records into patient episodes. A patient's episode includes each healthcare record pertaining to the same patient within a predetermined period centered on a record including a primary procedure. The procedure (primary or otherwise) may be identified by a procedure code or other known method to identify a given procedure (e.g., the name of the procedure). A primary procedure is one pertaining to with a major medical procedure. In some cases, the major procedure is the reason the patient went to the healthcare facility in the first place (e.g., spinal surgery, childbirth, appendectomy, repairing a stab wound, etc.). A given episode illustrates a number of procedure identifiers (“IDs”) (e.g. ancillary or preparatory tests) that a particular patient received, and the order in which those procedures were received. This data regarding episodes undertaken by individual patients is used as training data in a machine learning model.

The unsupervised machine learning system (“machine learning system”) then builds a model (for the primary procedure code) from the individual patient episodes experienced. Different models are generated for a number of different primary procedure codes. A given episode model may be represented as a graph including a series of paths. The paths include time steps, where, at each step, the path visits a node corresponding to a particular procedure code. Somewhere along each path is the primary procedure code. Each path varies between the selection (inclusion/omission) and order of procedure codes. Each path in the model is weighted based on the training data.

Using the model, and based on patient biographic data, or a location/region selected the model is able to determine a likely path for a particular patient that intends to receive the primary procedure. This information may be expressed to the patient as an explanation of the healthcare they will likely receive and an associated cost thereto.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a high-level block diagram illustrating a healthcare system according to some embodiments of the present disclosure;

FIG. 2 is a block diagram of a cost estimation system including computing devices in which the described techniques may be implemented according to some embodiments of the present disclosure;

FIG. 3 is an illustration of a graph associated with a healthcare episode model;

FIG. 4 is a flowchart illustrating generation of a healthcare episode;

FIG. 5 is a flowchart illustrating generation of an episode model;

FIG. 6 is a flowchart illustrating use of an episode model;

FIG. 7 is a temperature graph representation of a report from the episode model; and

FIG. 8 is a block diagram illustrating a computer operable to implement the disclosed technology according to some embodiments of the present disclosure.

### DETAILED DESCRIPTION

The embodiments set forth below represent the necessary information to enable those skilled in the art to practice the embodiments, and illustrate the best mode of practicing the embodiments. Upon reading the following description in light of the accompanying figures, those skilled in the art will understand the concepts of the disclosure and will recognize applications of these concepts that are not particularly addressed here. It should be understood that these concepts and applications fall within the scope of the disclosure and the accompanying claims.

The purpose of terminology used herein is only for describing embodiments and is not intended to limit the scope of the disclosure. Where context permits, words using the singular or plural form may also include the plural or singular form, respectively.

As used herein, unless specifically stated otherwise, terms such as “processing,” “computing,” “calculating,” “determining,” “displaying,” “generating,” or the like, refer to actions and processes of a computer or similar electronic computing device that manipulates and transforms data represented as physical (electronic) quantities within the computer's memory or registers into other data similarly represented as physical quantities within the computer's memory, registers, or other such storage medium, transmission, or display devices.

As used herein, terms such as “connected,” “coupled,” or the like, refer to any connection or coupling, either direct or indirect, between two or more elements. The coupling or connection can be physical, logical, or a combination thereof.

As used herein, the term “service” may refer to a healthcare related service or procedure provided by a healthcare provider to a patient. Examples include diagnoses or treatments performed by a doctor or performed at a facility such as a hospital.

As used herein, the term “provider” may refer to an entity that provides healthcare related services. Examples include a doctor, nurse, insurance carrier, practice group, facility, healthcare computer network service, or the like.

As used herein, the terms “consumer” or “patient” may refer to a user who receives services from a provider or who may use the disclosed technology. Furthermore, the term “user” may be a person or machine.

The disclosed embodiments generally relate to solving the problems faced by consumers seeking to know transparency in both the procedure and cost of a healthcare procedure. Healthcare is complicated and knowing “what to expect, when you're expecting [to visit the hospital]” is an important service to provide consumers. Undertaking many procedures (e.g., child delivery) can vary with respect to many factors. These variances have an effect on both cost and comfort of the patient. As a result, users are simply inadequately informed about the costs and cannot make informed decisions when selecting a provider for a particular procedure.

Estimating cost for healthcare services is challenging because of the high dimensionality of healthcare data (e.g., service codes, facilities, insurers), noise (e.g., medical coding is predominantly a manual process), missing data (e.g., a service may include an unrecorded procedure), and external validation is sparse (because this problem is challenging). Hence, healthcare data is interdependent, sparse, and inconsistent. The disclosed embodiments can deal with these challenges to provide accurate, interpretable, and useful cost estimates that are easy to explain to consumers.

The models are based on data contained in one or more data stores that may be accessible over one or more computer networks. In some embodiments, the models used to predict estimate costs (“estimation dataset”) can include or be limited to insurance claim records. An insurance claim record may include information related to a patient, healthcare providers, healthcare services, and the like. Accordingly, the data stores can include numerous healthcare claim records. The healthcare claim records can represent claims that range a span of years (e.g., dated 5 years back) and include information for a large population of patients (e.g., over 200 million patients) and a large population of healthcare providers (e.g., 900,000 doctors).

The estimation dataset includes a necessary and sufficient amount of healthcare related data to predict costs estimates for healthcare services. The estimation dataset is not readily available as interpretable accurate data contained in a single central data store. Instead, the estimation dataset may be fragmented and distributed across multiple data stores. Hence, users cannot simply retrieve cost estimates from any data store. In some embodiments, the estimation dataset is collected from disparate data sources and synthesized to predict the healthcare cost estimates. Further, in some embodiments, the collected estimation dataset can be anonymized to protect the privacy of patients and providers.

The disclosed technology is not simply a process for estimating a cost based on data collected from different sources because readily interpretable costs for healthcare services is not available in any data sources. Instead, predicting a cost estimate for a healthcare service involves understanding healthcare services and the structure and content of medical bills. For example, a particular service may involve one or more service codes that may be indicated in a medical bill. These service codes, or procedure codes, provide identification for procedures received. In some embodiments, service or procedure codes may be considered interchangeable with a particular cost/amount associated with a given healthcare facility.

In some embodiments, the disclosed technology can collect and parse incomplete or fragmented healthcare related information from one or more data sources to create an estimation dataset that defines one or more episodes of care. An episode of care can include one or more procedure codes and a price for each procedure code.

The unsupervised machine learning system disclosed herein includes several phases. Prior to beginning, the system uses a number of healthcare records. Amongst the records is data regarding an identification of patients and healthcare facilities, timestamps, procedure codes for the corresponding procedures performed on the patients, and biographic data for those patients.

The act of gathering and obtaining these healthcare records is outside the scope of this disclosure. Once obtained, the healthcare records are used in a first phase where training data for the unsupervised machine learning system is constructed. The training data for the machine learning system is a series of individual episodes of healthcare. The individual episodes reflect the experiences of individual patients. However, as an unsupervised system, the training data is unlabeled and not organized by patient. The system generates and identifies patterns within the data without having a preconceived programming indicating what it is looking for, or how the data should be modeled.

An individual healthcare episode includes each healthcare record pertaining to the same patient within a predetermined period of time centered on a record including a primary procedure code. A primary procedure code is a procedure code associated with a major procedure. In some cases, the major procedure is the reason the patient went to the healthcare facility in the first place (e.g., child delivery). A given episode illustrates a number of procedure codes (e.g., pre or post was natal activities) that a particular patient received, and the order in which those procedures were received.

The second phase of the machine learning system is to feed the training data (individual episodes) into the system. Using the training data, machine learning system generates a model (hidden Markov model). Healthcare episodes vary from individual to individual. The same selection of procedures will not necessarily be the same between individuals even if the respective individuals went to the hospital for the same reason. Further still, individuals having the same selection procedures do not necessarily cost the same. Costs for procedures may vary from facility to facility, insurance provider to insurance provider, or even doctor to doctor. Through the use of thresholds, the system is able to generate a predictive effect with respect to healthcare episodes received by future patients based on the specific circumstances of each of those future patients.

Different models are generated for a number of different primary procedure codes. A given episode model may be represented as a graph including a series of paths. The paths include time steps, where, at each step, the path visits a node corresponding to a particular procedure code. Somewhere along each path is the primary procedure code. Each path varies between the selection (inclusion/omission) and order of procedure codes. Each path in the model is weighted based on the training data.

Using the model, and based on patient biographic data, or a location/region selected the model is able to determine a likely path for a particular patient that intends to receive the primary procedure. This information may be expressed to the patient as an explanation of the healthcare they will likely receive and an associated cost thereto.

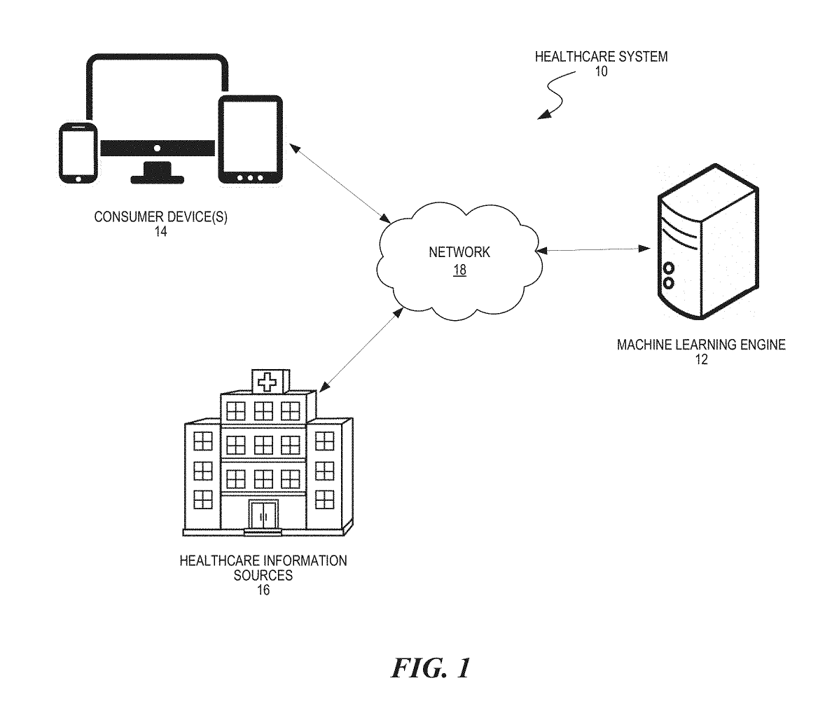

FIG. 1 is a block diagram of a healthcare system 10 operable to estimate costs of healthcare procedures according to some embodiments of the present disclosure. The healthcare system 10 can generate cost estimates for procedure per provider. The cost estimates can be made available to consumers and providers to make more informed healthcare decisions. The healthcare system 10 includes components such as one or more servers of a cost estimator 12, consumer devices 14, and healthcare information sources 16, all interconnected over a network 18 such as the Internet.

The network 18 may include any combination of private, public, wired, or wireless portions. The data communicated over the network 18 may be encrypted or unencrypted at various locations or along different portions of the network 18. Each component of the healthcare system 10 may include combinations of hardware and/or software to process data, perform functions, communicate over the network 18, and the like. For example, any component of the healthcare system 10 may include a processor, memory or storage, a network transceiver, a display, operating system and application software (e.g., for providing a user interface), and the like. Other components, hardware, and/or software included in the healthcare system 10 that are well known to persons skilled in the art are not shown or discussed herein for brevity.

The consumer devices 14 (referred to collectively as consumer devices 14 and individually as consumer device 14) are used by consumers to interact with the healthcare system 10. Examples of consumer devices 14 include smartphones (e.g., APPLE IPHONE, SAMSUNG GALAXY, NOKIA LUMINA), tablet computers (e.g., APPLE IPAD, SAMSUNG NOTE, AMAZON FIRE, MICROSOFT SURFACE), computers (e.g., APPLE MACBOOK, LENOVO 440), and any other electronic computing device that is capable of accessing information of the cost estimator 12 over the network 18.

The cost estimator 12 may include any number of server computers that operate to estimate costs of healthcare procedures based on healthcare information. The cost estimator 12 may operate to collect a variety of public or provide healthcare data from the healthcare information sources 16. The collected healthcare data is used to estimate the cost of a procedure per healthcare provider and estimate a payout by insurers for a procedure. The healthcare information sources 16 may include any number of servers or other devices that collect, store, generate, and/or provide healthcare-related information to the cost estimator 12 over the network 18.

The healthcare information sources 16 may include any source of healthcare information. For example, the healthcare information sources 16 may include medical facilities, private offices, or devices operated by healthcare professionals. In some embodiments, the healthcare information includes at least portions of claims records, insurer payouts for procedures, or a public fee schedule.

In some embodiments, the cost estimator 12 may provide or administer a portal that allows consumers devices 14 to access a library of information related to healthcare providers and estimated costs for healthcare services. Examples of a portal include a website, mobile application (app), or any channels for providing information about cost-estimation services to the consumer devices 14. As such, the consumer devices 14 can access and filter information about providers, insurers, or cost estimates through the portal of the cost estimator 12. The data processing techniques described herein are suitable for use by systems deployed in a variety of operating environments.

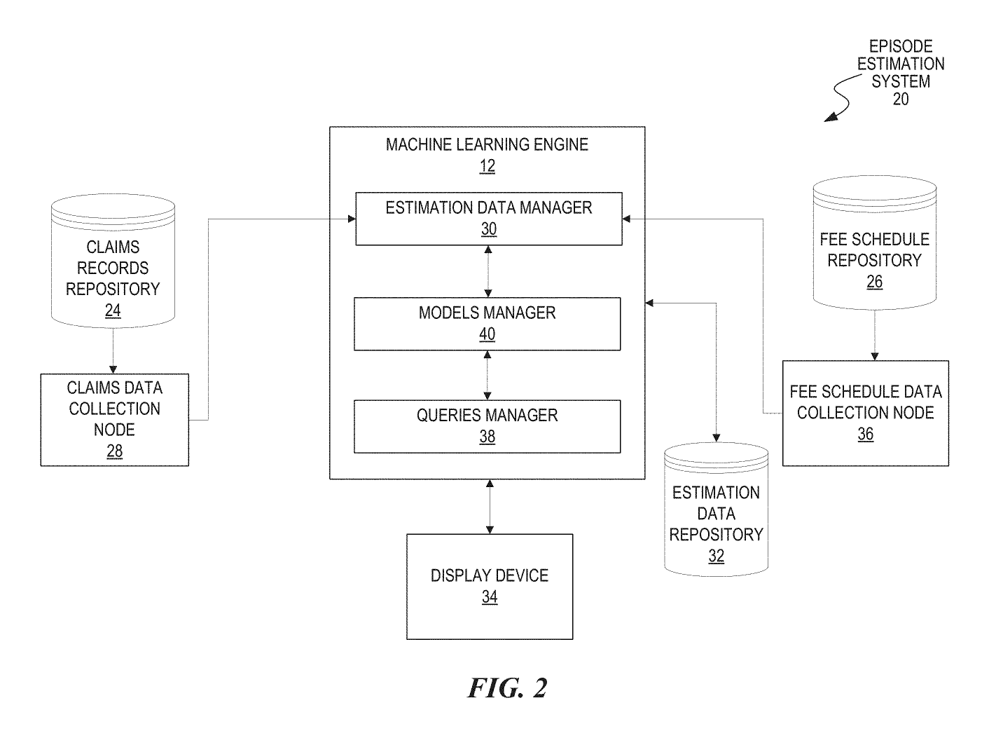

FIG. 2 is a block diagram of an episode estimation system 20 of computing devices in which the described technology may be implemented according to some embodiments of the present disclosure. The cost estimator 12 represents server(s) that collect and combine (e.g., correlate) data from both a claims records repository 24 and a fee schedule repository 26.

A claims data collection node 28 obtains claims data from the claims records repository 24. In some embodiments, the claims data collection node 28 can collect claims data by making calls to an application program interface (API) made available by an estimation data manager 30. The claims data collection node 28 may be configured to re-structure or otherwise modify the claims data obtained from the claims records repository 24 to conform to a particular format before being forwarded to the estimation data manager 30 of the cost estimator 12.

The estimation data manager 30 can store the claims data received from claims data collection node 28 in one or more indexes in an estimation data repository 32, which is communicatively coupled to the cost estimator 12. The cost estimator 12 includes instructions for the display of graphical interfaces that may be presented to consumers for obtaining cost estimates of healthcare services. The cost estimator 12 may cause graphical interfaces to display at a display device 34 of a consumer device 14.

A fee schedule data collection node 36 collects fee schedule data from the fee schedule repository 26. In some embodiments, fee schedule data collection node 36 collects fee schedule data by making calls to an API made available by the estimation data manager 30. Accordingly, the claims data collection node 28 and the fee schedule data collection node 36 may forward their data to the estimation data manager 30.

The fee schedule data collection node 36 may be configured to re-structure or otherwise modify the data obtained from the fee schedule repository 26 to conform to a particular format before forwarding the fee schedule data to the estimation data manager 30 at the cost estimator 12. In some embodiments, the estimation data manager 30 can also modify the claims data and fee schedule data to conform to the same format for easier retrieval of both types of data.

The estimation data manager 30 stores the fee schedule data received from the fee schedule repository 26 in one or more indexes in the estimation data repository 32, which is communicatively coupled to the cost estimator 12. The cost estimator 12 also includes instructions for the display of graphical interfaces that may be presented to consumers for estimating costs of healthcare services.

The queries manager 38 of the cost estimator 12 may query the models manager 40 to perform a cost estimate based on an episode of care of a model managed by the models manager 40. Thus, the models manager 40 has access to both collections data and fee schedule data stored in the estimation data repository 32. In an embodiment, software is used to implement functions practiced by any of the computing devices of the episode estimation system 20, including software, which when executed, performs the functionality of any of the computing devices of the episode estimation system 20.

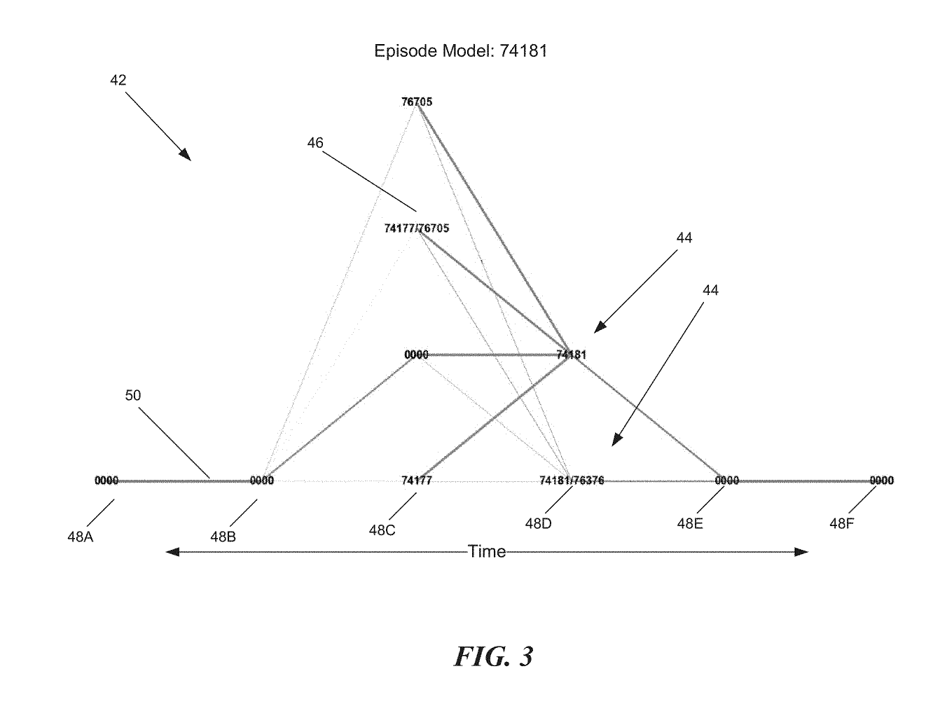

FIG. 3 is an illustration of a graph associated with a healthcare episode model 42. The pictured healthcare episode model 42 is centered about the chosen primary procedure code 44, “74181”. The exact number of the primary procedure code 44 is arbitrary and would vary from episode model 42 to episode model 42. Each path represented on the graph goes through a node 46 including the primary procedure code 44, “74181”. The graph operates as a function of time. Time is measured in vertical slices. In FIG. 3, there are six periods of time, corresponding to the six vertical slices or levels 48.

All nodes 46 in the graph are positioned into one of the available levels 48. Nodes 46 in the graph are connected between one another by edges 50. A given path in the model traverses the graph from left to right, visiting each level 48 exactly once. At some nodes 46 there are multiple procedure codes. In those cases, and on those paths, more than one procedure was performed during that time slice or level 48. Levels 48 may be defined by a predetermined interval. For example, an interval may be a given hour, a given day, or a given week.

In FIG. 3, all paths traverse through the primary procedure code 44 in the fourth level from the left 48D. In a given path, starting from the left, a patient receives “0000” (e.g., no procedure) at the first level 48A, “0000” at the second level 48B, “76705” at the third level 48C, “74181” at the fourth level 48D, “0000” at the fifth level 48E, and “0000” at the sixth level 48F.

The graph is full in the sense that there is one edge 50 between each node 46 of the first level 48 and all nodes 46 of the subsequent level 48. Frequency of paths is represented by the thickness of the edges 50. While the episode model 42 includes specific data as to the frequency of each path, edge thickness is used to visually display frequency in FIG. 3. For example, in the second level 48B, there is a single node 46 (“0000”). There are four edges 50 with the greatest frequency corresponding to a node 46 that also corresponds to “0000”. The path with the greatest frequency in the graph only passes through a single node 46 including an active procedure code, that procedure code being the primary procedure code 44.

The healthcare episode model 42 displayed in FIG. 3 illustrates a relatively simple healthcare episode. In many cases, healthcare episodes include a far greater number of procedure codes, and a correspondingly greater variance in paths. While not displayed in the graph the healthcare episode model 42 includes data regarding each patient contributing training data to the model 42. For example, this data may include an age of the patients, sex of the patients, preexisting conditions of the patients, body weight of the patients, blood pressure measurements for the patients, family history for the patients, the doctors treating the patients, and the healthcare facility the patients receive care at.

In some embodiments, the unsupervised machine learning system categorizes some or all of the patient data into brackets (e.g., age bracket such as 10 to 20, or 20 to 30). The brackets may vary based on primary procedure code 44. For any given set of patient data, there is a most likely path but traverses the graph. However the most likely path isn't always necessarily one that the healthcare episode model 42 will predict.

When determining the procedure codes to include in a given healthcare episode model, outlier procedure codes are omitted. In many cases, patients visit healthcare facilities for more than reason at a time. In those circumstances, their visit will include procedure codes that are not included in the similar healthcare episodes of other patients (or only included in a statistically irrelevant number of other patients). For example, data for a healthcare episode for an appendectomy might include one patient who also received medication for a skin disorder. In this example, the procedure code for the skin disease medication is an outlier and is omitted from the model.

Some data fields may be more relevant than other data fields. This may be determined using thresholds on the graph. For example if a given patient fits within an age bracket that would dictate a first traversal path, or edge choice, and fits within a family medical history bracket that would dictate a second traversal path or edge choice, one of these data fields must control. Machine learning system determines the controlling data field based on thresholds in the data. At each node 46 in the path, the machine learning system determines a subsequent edge 50. The system evaluates which data fields have the greatest controlling effect in that particular episode model 42, for that particular level 48, egressing from that particular node 46. This evaluation examines both the total population within the training data as an aggregate, and those individuals in the training data having the greatest number of similarities to the subject or current patient.

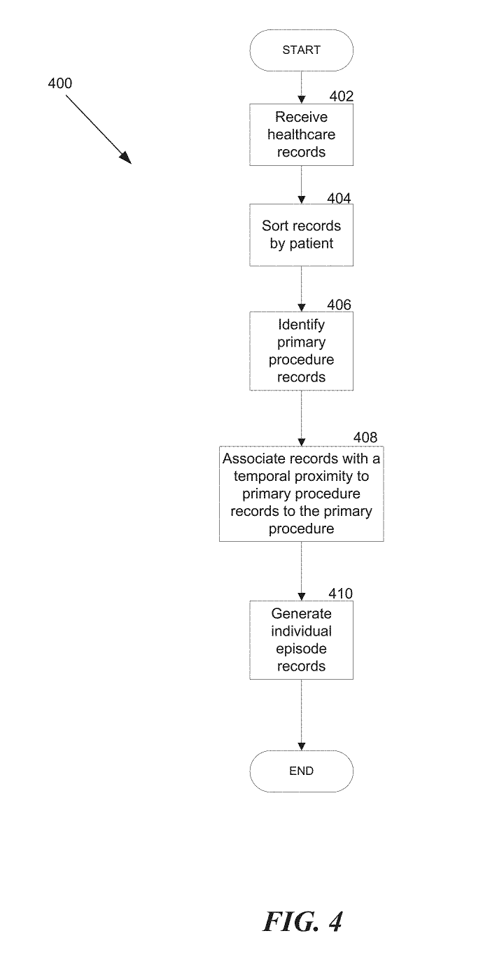

FIG. 4 is a flowchart illustrating generation of a healthcare episode. In step 402, the machine learning system receives healthcare records. Each healthcare record includes a patient ID, a procedure code, a timestamp, and biographic and demographic data about both the healthcare facility and the patient. In step 404, the machine learning system sorts the healthcare records by patient ID. In this manner, records are placed into sorted groups each pertaining to a given patient.

In step 406, the machine learning system identifies primary procedure records from each sorted group. A primary procedure record is one that includes a primary procedure code. The primary procedure code is associated with a primary procedure. A primary procedure is one which multiple procedures are associated with. In some embodiments, the primary procedure is the reason that the patient decided to visit a healthcare facility (e.g., setting a broken arm, giving birth, heart surgery, etc.). Each of these primary procedures is likely to have one or more ancillary procedures associated it with. When the patient went to the healthcare facility, they also obtained other procedures. Those other procedures may include tests performed before or after the primary procedure, patient condition stabilization, doctor consult, facility expenses (e.g., room and board, food, medication etc.), or other procedure types known in the art.

In step 408, the machine learning system associates records with temporal proximity to the primary procedure records to the primary procedure. The temporal proximity is determined by a predetermined time interval. For example, temporal proximity may be within 30 days, in each direction, of the timestamp of the primary procedure record. The temporal proximity time interval may also vary based on the primary procedure. Where there is overlap in healthcare records, such that a given healthcare record pertains to two or more primary procedure records, that healthcare record is associated with both primary procedure records.

In step 410, each set of associated records are packaged into an episode record. Each episode record is categorized and sorted by primary procedure code. Each individual patient may have one or more episode records associated with them.

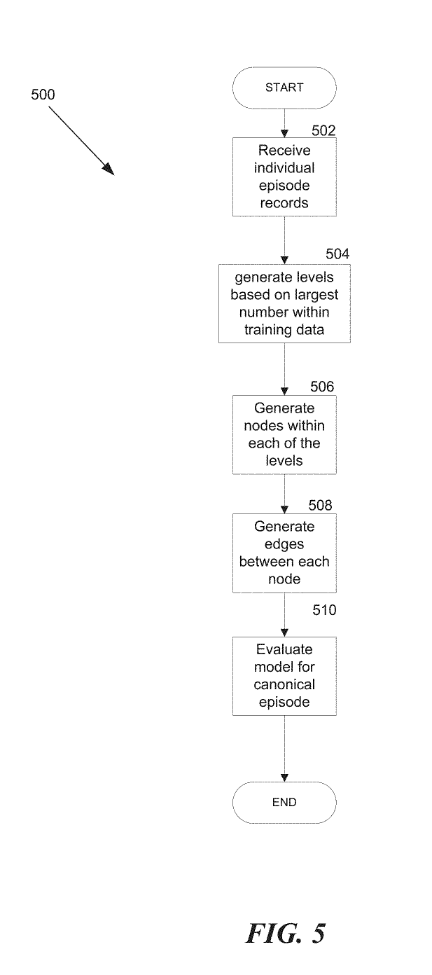

FIG. 5 is a flowchart illustrating generation of an episode model. In step 502, the machine learning system receives each of the episode records (as generated in step 410 of FIG. 4). In step 504, the system generates levels within a model based on the episode record having the largest number of healthcare records on different timestamp intervals. A timestamp interval may be, for example, a day. However, in some embodiments, the timestamp interval is greater or shorter than a day. The timestamp interval differs from the predetermined time interval used in step 408 of FIG. 4. Where the predetermined time interval refers to the breadth of a given episode, the timestamp interval refers to the granularity in which events within an episode are ordered.

In step 506, the system populate each of the levels generated in step 504 with nodes. Each node includes one or more procedure codes found within each episode record. Procedure code placement within nodes in each level is based upon the order in which the procedure codes, and therefore associated procedures, were received by the patient and not necessarily the exact number of timestamp intervals away from adjacent procedure codes.

For example, for two given episode records pertaining to the same primary procedure code, the procedure code received immediately after the primary procedure code may have occurred on the day afterwards in one episode record and four days afterwards in the second episode record. Despite this, the nodes associated with these procedure codes would both appear in the level associated with “primary code +1”. Thus the delineation of nodes into levels is first based on procedure codes occurring at least one timestamp interval away from one another, and then based on the order the procedure codes received in each respective episode record. In this manner, the episode records are lined up with one another in a comparable manner.

In step 508, the system generates it edges between each node in the model based on the episode records. Each edge represents the path taken by a particular patient within a particular episode record. Each edge represents an occurrence of a particular order of two nodes (procedure codes). A count of occurrences provides frequency data for particular tasks and sub paths within a given healthcare episode across the entire population of the training data. Further each edge includes the biographic and demographic data of each patient in the healthcare facility that patient visited.

In step 510, the machine learning system evaluates the model with a Markov chain to determine canonical episodes. Below are equations illustrating the Markov chain:

P(codeᵢcode₋ᵤ . . . code₍ᵢ₋₁₎,patient characteristics)=P(codeᵢ|code₍ᵢ₋₁₎,patient characteristics)

P(e|patient characteristics procedure)=π_{i=-u . . . v}P(codeᵢ|code₍ᵢ₋₁₎,patient characteristics)

In the equation, “u” is the earliest procedure code in order before the occurrence of the primary procedure code, and “v” is the latest procedure code in order after the primary procedure code. Thus, a given episodes proceeds from “u” to “v”.

The equation above describes the probability that a given procedure is included in an episode as following a previous code. In the absence of patient specific information, the model identifies the probability of each episode as well as the most likely episode. In the most general case, the method identifies the most likely path for all patients. This is a canonical episode. However, provided specific characteristics (e.g., age, gender, or a pre-existing condition, etc.), the method will find the most likely path for those patient characteristics.

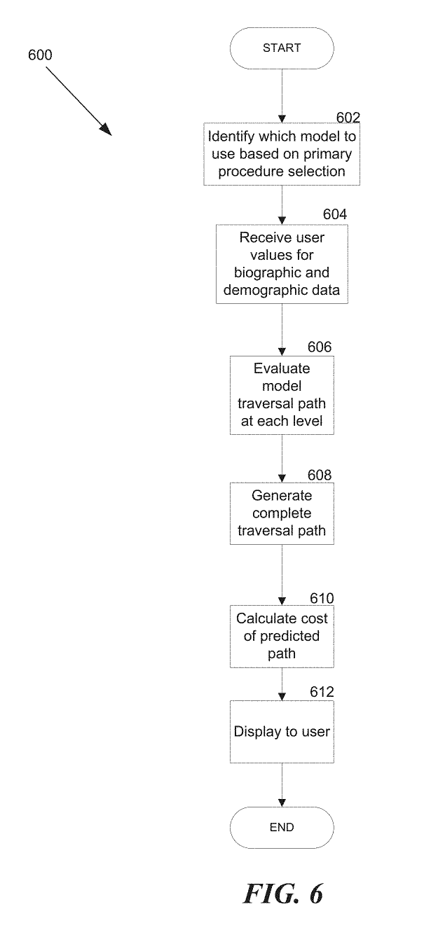

FIG. 6 is a flowchart illustrating use of an episode model. In step 602, the system identifies which model the user based on a primary procedure selection of the user. The selection of the primary procedure is received through a user interface such as a web client. When the system receives a selection of a primary procedure, the system retrieves the model associated with that primary procedure.

In step 604, the system receives user values for biographic and demographic data. The system may receive this data through either manual insertion through a user interface, via a file upload, or user profile. The data includes items such as the patient's age, the patient's sex, any pre-existing conditions the patient discloses, patient's weight, the patient's blood pressure, a family medical history for the patient or list of maladies the patient is prone to, a home region for the patient, or a doctor preference for the patient. The home region refers to a local area that may include multiple healthcare centers. Alternatively, the home region may refer to a single healthcare center. In some embodiments, variable information may be submitted. For example, multiple healthcare facilities or multiple doctors may be submitted in order to generate a number of traversal paths or to demonstrate to the patient the potential variability based on differences in these choices.

In step 606, the system evaluates a traversal path through the selected model, at each level, as for the current subject patient. Using the Markov chain, the system evaluates the current patient at each level of the model to determine a node for that level. The data collected in step 604 is used to evaluate the probabilities for each particular node in the level. The system evaluates probabilities both at a complete and total profile level and a most determined factor level. For example, for each next node in a path there is a most likely decision based on the summation of all individual biographic and demographic patient data. There is likely also a given factor that is more determinative than the rest. For example, if across a given model a certain age group often receives a given procedure code it is likely that a patient within that age group will also receive that procedure code; however, if the patient attends a healthcare facility that uses a different procedure code hundred percent of the time, then the choice of healthcare facility is the greatest determining factor.

In step 608, the system generates a complete traversal path of the model for the given patient. The traversal path will include visits to one note at each level of the model and list each procedure code that a patient with the identified biographic and demographic data would likely receive one obtaining the selected primary procedure. Where variable biographic and demographic data is entered, multiple traversal paths are generated.

In step 610, the system calculates a cost for the traversal path. The calculated cost can be obtained by using information pertaining to the relevant healthcare facility or doctor, or drawn from insurance claims data. Hospitals will often have fixed costs associated with different procedure codes. Therefore, when given a list of procedure codes, a total cost may be calculated. As noted in step 604, where variable biographic and demographic data is entered, the multiple traversal paths are generated, the same is performed for calculating multiple total costs.

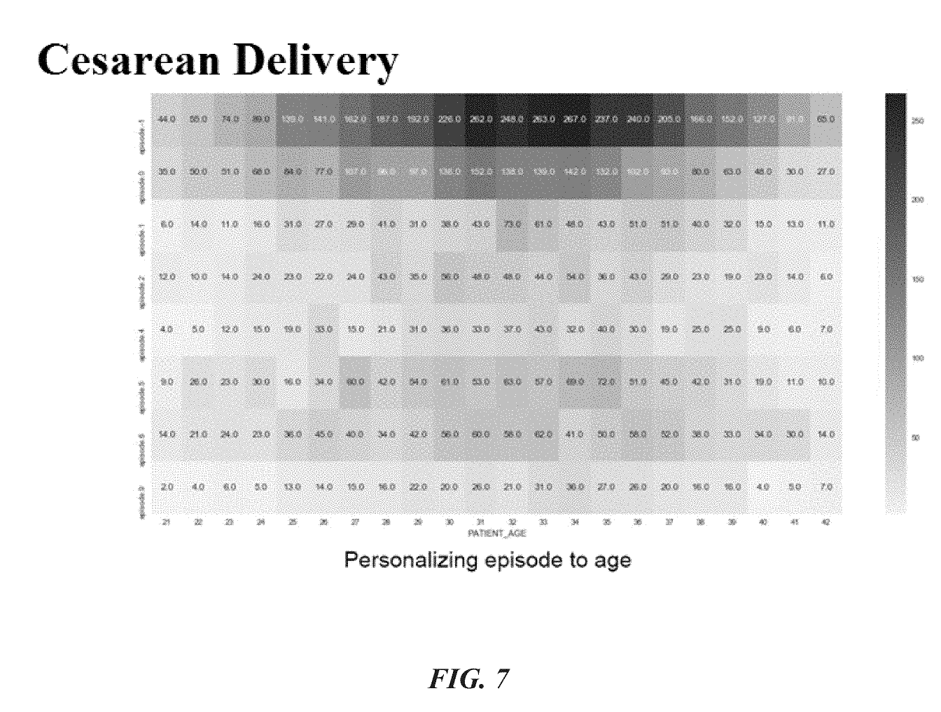

FIG. 7 is a temperature graph representation of a report from the episode model. Episode models may be used to for purposes beyond predicting future patient interaction with the healthcare system. The models also generate analytical information concerning procedure code trends. Displayed is a temperature graph showing a number of episodes (y-axis) of a Cesarean delivery (primary procedure) across a variable number of ages (x-axis). The two episodes at the top of the graph are the most common further the graph demonstrates an age range where the primary procedure is also most common. A distinction that the graph shows is that the top episode is very common across a wider age range than the episode second from the top.

The variable chosen across the x-axis of this chart (age) is arbitrary and any of the variables discussed herein may be substituted therefor. Generation of charts enables healthcare professionals and insurance providers to analyze trends across the total healthcare system.

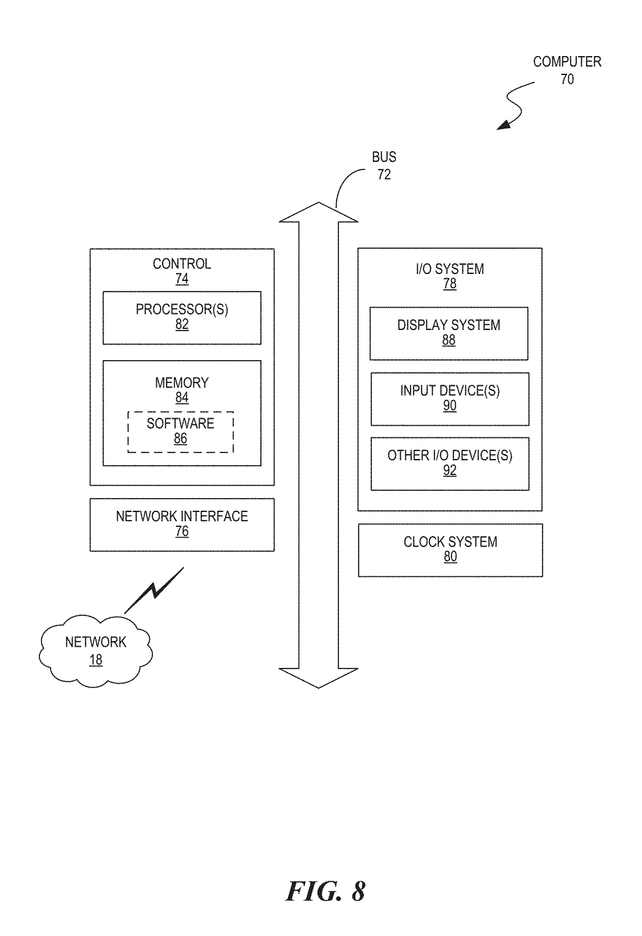

FIG. 8 is a block diagram of a computer 70 operable to implement the disclosed technology according to some embodiments of the present disclosure. The computer 70 may be a generic computer or specifically designed to carry out features of healthcare system 10. For example, the computer 70 may be a system-on-chip (SOC), a single-board computer (SBC) system, a desktop or laptop computer, a kiosk, a mainframe, a mesh of computer systems, a handheld mobile device, or combinations thereof.

The computer 70 may be a standalone device or part of a distributed system that spans multiple networks, locations, machines, or combinations thereof. In some embodiments, the computer 70 operates as a server computer (e.g., the cost estimator 12 or healthcare information sources 16) or a client device (e.g., consumer devices 14) in a client-server network environment, or as a peer machine in a peer-to-peer system. In some embodiments, the computer 70 may perform one or more steps of the disclosed embodiments in real time, near real time, offline, by batch processing, or combinations thereof.

As shown in FIG. 8, the computer 70 includes a bus 72 that is operable to transfer data between hardware components. These components include a control 74 (e.g., processing system), a network interface 76, an input/output (I/O) system 78, and a clock system 80. The computer 70 may include other components that are not shown nor further discussed for the sake of brevity. One who has ordinary skill in the art will understand elements of hardware and software that are included but not shown in FIG. 8.

The control 74 includes one or more processors 82 (e.g., central processing units (CPUs)), application-specific integrated circuits (ASICs), and/or field-programmable gate arrays (FPGAs), and memory 84 (which may include software 86). For example, the memory 84 may include volatile memory, such as random-access memory (RAM), and/or non-volatile memory, such as read-only memory (ROM). The memory 84 can be local, remote, or distributed.

A software program (e.g., software 86), when referred to as “implemented in a computer-readable storage medium,” includes computer-readable instructions stored in the memory (e.g., memory 84). A processor (e.g., processor 82) is “configured to execute a software program” when at least one value associated with the software program is stored in a register that is readable by the processor. In some embodiments, routines executed to implement the disclosed embodiments may be implemented as part of an operating system (OS) software (e.g., Microsoft Windows® and Linux®) or a specific software application, component, program, object, module, or sequence of instructions referred to as “computer programs.”

As such, the computer programs typically comprise one or more instructions set at various times in various memory devices of a computer (e.g., computer 70), which, when read and executed by at least one processor (e.g., processor 82), will cause the computer to perform operations to execute features involving the various aspects of the disclosed embodiments. In some embodiments, a carrier containing the aforementioned computer program product is provided. The carrier is one of an electronic signal, an optical signal, a radio signal, or a non-transitory computer-readable storage medium (e.g., memory 84).

The network interface 76 may include a modem or other interfaces (not shown) for coupling the computer 70 to other computers over the network 18. The I/O system 78 may operate to control various I/O devices, including peripheral devices, such as a display system 88 (e.g., a monitor or touch-sensitive display) and one or more input devices 90 (e.g., a keyboard and/or pointing device). Other I/O devices 92 may include, for example, a disk drive, printer, scanner, or the like. Lastly, the clock system 90 controls a timer for use by the disclosed embodiments.

Operation of a memory device (e.g., memory 84), such as a change in state from a binary one (1) to a binary zero (0) (or vice versa) may comprise a visually perceptible physical change or transformation. The transformation may comprise a physical transformation of an article to a different state or thing. For example, a change in state may involve accumulation and storage of charge or a release of stored charge. Likewise, a change of state may comprise a physical change or transformation in magnetic orientation or a physical change or transformation in molecular structure, such as a change from crystalline to amorphous or vice versa.

Aspects of the disclosed embodiments may be described in terms of algorithms and symbolic representations of operations on data bits stored in memory. These algorithmic descriptions and symbolic representations generally include a sequence of operations leading to a desired result. The operations require physical manipulations of physical quantities. Usually, though not necessarily, these quantities take the form of electric or magnetic signals that are capable of being stored, transferred, combined, compared, and otherwise manipulated. Customarily, and for convenience, these signals are referred to as bits, values, elements, symbols, characters, terms, numbers, or the like. These and similar terms are associated with physical quantities and are merely convenient labels applied to these quantities.

While embodiments have been described in the context of fully functioning computers, those skilled in the art will appreciate that the various embodiments are capable of being distributed as a program product in a variety of forms and that the disclosure applies equally, regardless of the particular type of machine or computer-readable media used to actually effect the embodiments.

While the disclosure has been described in terms of several embodiments, those skilled in the art will recognize that the disclosure is not limited to the embodiments described herein and can be practiced with modifications and alterations within the spirit and scope of the invention. Those skilled in the art will also recognize improvements to the embodiments of the present disclosure. All such improvements are considered within the scope of the concepts disclosed herein. Thus, the description is to be regarded as illustrative instead of limiting.

From the foregoing, it will be appreciated that specific embodiments of the invention have been described herein for purposes of illustration, but that various modifications may be made without deviating from the scope of the invention. Accordingly, the invention is not limited except as by the appended claims.

1. A method of identifying component procedures in a healthcare episode via unsupervised machine learning models comprising:
obtaining a plurality of healthcare records corresponding to a healthcare facility, each of the plurality of records having fields, the fields including:
a procedure ID;
a patient ID;
biographic data; and
a timestamp;
generating a plurality of path records of a plurality of healthcare episodes based on the plurality of healthcare records, wherein a given healthcare episode includes each healthcare record having a same patient ID within a predetermined period of time, as determined by the timestamp, from a given healthcare record including a primary procedure, a given episode record illustrates a plurality of procedure IDs that a particular patient received within the predetermined period of time of the primary procedure;
generating a healthcare episode model for the primary procedure based on the plurality of path records, the healthcare episode model including a plurality of paths of time ordered procedure IDs that includes the primary procedure, each of the plurality of paths indexed by the biographic data of the plurality of healthcare records; and
determining a probability of occurrence of each of the plurality of paths through the healthcare episode model.

2. The method of claim 1, further comprising:
determining a particular path for a certain patient receiving the primary procedure including certain biographic data based on a decision threshold and the healthcare episode model.

3. The method of claim 2, wherein the fields of the healthcare records further comprise:
a location; and
said determining a particular path for a certain patient is further based on the certain biographic data for the certain patient including a corresponding location.

4. The method of claim 1, wherein each procedure ID includes an associated cost, and said determining the canonical path further includes generating an estimated cost for the canonical path based on a summation of the associated cost included with each procedure ID associated with the particular path.

5. The method of claim 1, wherein the healthcare episode model is a graph comprising:
nodes each corresponding to a given procedure ID;
edges connecting two nodes; and
levels organized by a series of temporal periods, wherein all of the nodes are organized into the levels.

6. The method of claim 5, wherein the particular path further comprises a series of edges that traverse each of the levels and including one node from each level.

7. The method of claim 5, wherein each of the edges further comprise a weighting based on the plurality of healthcare episodes and corresponding to a frequency a particular ordering of procedure IDs occurs in the plurality of healthcare episodes.

8. The method of claim 1, wherein the certain biographic data used in determining the particular path comprises any of:
an age of the certain patient;
a sex of the certain patient;
a preexisting condition of the certain patient;
a weight of the certain patient;
a blood pressure of the certain patient; or
a family history of the certain patient.

9. The method of claim 4, further comprising:
displaying an estimated cost for the particular path as varied from each of the plurality of healthcare facilities.

10. A method of identifying component procedures in a healthcare episode via unsupervised machine learning models comprising:
generating a healthcare episode model from a plurality of healthcare records, the plurality of healthcare records used to generate the healthcare episode model are sorted by procedure code and chosen based on patient and temporal proximity to a particular procedure code such that the plurality of healthcare records indicate that each patient had received a particular procedure associated with the particular procedure code, wherein the healthcare episode model includes a plurality of nodes and edges, each node associated with one of a plurality of procedure codes, each edge associated with an ordered list of procedure codes undertaken by a given patient, each of the plurality of healthcare records further including biographic data for patients;
determining a probability of occurrence of each ordered list based on the healthcare episode model; and
determining a canonical ordered list based on having a highest probability of occurrence.

11. The method of claim 10, further comprising:
determining a certain ordered list for a certain patient receiving the primary procedure code including certain biographic data based on a decision threshold and the healthcare episode model.

12. The method of claim 10, wherein each procedure codes of the plurality of procedure codes includes an associated cost, and said determining the certain path further includes generating an estimated cost for the certain path based on a summation of the associated cost included with each procedure code associated with the certain path.

13. The method of claim 10, wherein the healthcare episode model is a graph further comprising:
levels organized by a series of temporal periods, wherein all of the nodes are organized into the levels and connected there between by the edges.

14. The method of claim 13, wherein the canonical ordered list further comprises a series of edges that traverse each of the levels and including one node from each level.

15. The method of claim 10, wherein each of the edges further comprise a weighting based on the plurality of healthcare records and corresponding to a frequency a particular ordering of procedure codes occurs in the plurality of healthcare records.

16. The method of claim 10, wherein the certain biographic data used in determining the certain path comprises any of:
an age of the certain patient;
a sex of the certain patient;
a preexisting condition of the certain patient;
a weight of the certain patient;
a blood pressure of the certain patient; or
a family history of the certain patient.

17. A system of identifying component procedures in a healthcare episode via unsupervised machine learning models comprising:
a processor; and
memory including instructions that, when executed by the processor, cause the computer system to:
obtain a plurality of healthcare records corresponding to a healthcare facility, each of the plurality of records having fields, the fields including:
a procedure code;
a patient ID;
biographic data; and
a timestamp;
generate a plurality of path records of a plurality of healthcare episodes based on the plurality of healthcare records, wherein a given healthcare episode includes each healthcare record having a same patient ID within a predetermined period of time, as determined by the timestamp, from a given healthcare record including a primary procedure code, a given path record illustrates a plurality of procedure codes that a particular patient received within the predetermined period of time of the primary procedure code;
generate a model for the primary procedure code based on the plurality of path records, the model including a plurality of paths of time ordered procedure codes that includes the primary procedure code, each of the plurality of paths indexed by the biographic data of the plurality of healthcare records;
determine a probability of occurrence of each of the plurality of paths through the healthcare episode model; and
determining a canonical path of the plurality paths based on having a highest probability of occurrence of each of the plurality of paths through the healthcare episode model.

18. The system of claim 17, wherein the fields of the healthcare records further comprise:
a location; and
said determine a particular path for a certain patient is further based on the certain biographic data for the certain patient including a corresponding location.

19. The system of claim 17, wherein each procedure code includes an associated cost, and said determining the canonical path further include generating an estimated cost for the canonical path based on a summation of the associated cost included with each procedure code associated with the particular path.

20. The system of claim 17, wherein the healthcare episode model is a graph comprising:
nodes each corresponding to a given procedure code;
edges connecting two nodes; and
levels organized by a series of temporal periods, wherein all of the nodes are organized into the levels.

21. The system of claim 20, wherein the canonical path further comprises a series of edges that traverse each of the levels and including one node from each level.

22. The system of claim 20, wherein each of the edges further comprise a weighting based on the plurality of healthcare episodes and corresponding to a frequency a particular ordering of procedure codes occurs in the plurality of healthcare episodes.

23. The system of claim 19, wherein the memory further including instructions that, when executed by the processor, cause the computer system to:
display an estimated cost for the canonical path as varied from each of a plurality of healthcare facilities.
